(19) United States
(12) Patent Application Publication
(10) Pub. No.: US 2003/0221007 A1
(43) Pub. Date: Nov. 27, 2003

(54) Method and system of crisis management for an application server

(76) Inventors: Cheng-Hui Chiu, Miaoli Hsien (TW); Ching-Chung Chang, Changhua City (TW)

Correspondence Address: BIRCH STEWART KOLASCH & BIRCH, PO BOX 747, FALLS CHURCH, VA, 22040-0747, US

(21) Appl. No.: 10/265,269

(22) Filed: Oct. 7, 2002

(30) Foreign Application Priority Data
May 27, 2002 (TW) 91111209

(51) Int. Cl. G06F 15/173

(52) U.S. Cl. 709/225; 365/203

(57) ABSTRACT

A method of crisis management for an application server. The method comprises steps of storing a first threshold, creating an engine operating in normal mode wherein the engine opens and closes a session for each client logging onto and off of the application server respectively, monitoring occupied memory space of the engine resulting from the opening of the sessions, switching the engine from normal mode to drain mode wherein the engine does not open sessions for new clients but continues closing sessions for clients logging out when the occupied memory space is larger than the first threshold, and shutting down the engine operating in drain mode when all the sessions are closed.

### BACKGROUND OF THE INVENTION

1. Field of the Invention

The present invention relates to a system and method of crisis management for an application server and particularly to a system and method of memory management for the application server, which prevents engines of the server from exhausting the memory.

2. Description of the Prior Art

As the Internet becomes a more and more popular media for connecting people, many enterprises use it as an efficient platform for interaction with customers or suppliers. This B2B web solution is achieved by application servers.

For example, BroadVision Application Server is adopted by many enterprises to achieve the B2B web solution. It creates engines called Interaction Manager (IM) to process requests from clients. The IM engines open sessions for new clients logging onto the application server. After a predetermined period of time during which logged-in clients do not make any request or when the clients log off of the server, the IM engines close the sessions for them. Each of the sessions occupies a space in the memory of the server.

However, in the conventional BroadVision Application Server, the memory space occupied by the sessions is not released even after the sessions are closed by the IM engines. As new clients log onto the server, the occupied memory space never stops increasing. It is inevitable that the limited memory space will be exhausted and the server may even crash after a period of time. The only solution to this problem is to shut down and reset the server. Thus, the clients will suffer inconvenience when the server suspends service during shutdown and resetting.

### SUMMARY OF THE INVENTION

The object of the present invention is to provide a system and method of memory management for the application server, which prevents engines of the server from exhausting the memory.

The present invention provides a method of crisis management for an application server. The method comprises steps of storing a first threshold, creating an engine operating in a normal mode wherein the engine opens and closes a session for each client logging onto and off of the application server respectively, monitoring an occupied memory space of the engine resulting from the opening of the sessions, switching the engine from normal mode to drain mode wherein the engine does not open sessions for new clients but continues closing sessions for clients logging out when the occupied memory space is larger than the first threshold, and shutting down the engine operating in drain mode when all the sessions are closed.

The present invention further provides a system of crisis management for an application server comprising means for storing a first threshold, creating an engine operating in normal mode wherein the engine opens and closes a session for each client logging onto and off of the application server respectively, monitoring an occupied memory space of the engine resulting from the opening of the sessions, and for switching the engine from normal mode to drain mode wherein the engine does not open sessions for new clients but continues closing sessions for clients logging out when the occupied memory space is larger than the first threshold, and shutting down the engine operating in drain mode when all the sessions are closed.

Thus, in the present invention, the memory usage of the IM engines is monitored using a shell script. The IM engines switch to drain mode when they occupy memory space larger than a given threshold. The IM engines operating in drain mode will not open new sessions for new clients but continue closing sessions for logging-out clients. The drain-mode engines are closed if all the sessions therein are closed, which frees up memory space.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a flowchart of a method of crisis management for an application server according to one embodiment of the invention.

FIG. 2 is a diagram showing a system of crisis management for an application server according to one embodiment of the invention.

### DETAILED DESCRIPTION OF THE INVENTION

In the application server of this embodiment, a shell script WATCH_IM is used to monitor the IM engine's status every ten minutes. A utility IMGR_UTL switches the operating mode of an IM engine from normal to drain if the IM engine occupies memory space larger than a given threshold such as 500 MB. The IM engine operating in drain mode does not open new sessions for new clients but continues closing sessions for logging-out clients. The IM engine in drain mode is closed if all the sessions therein are closed, freeing up memory space.

Another script WATCHER is used to monitor the number of existing engines every ten minutes. A new engine will be created to replace the eliminated engine. For example, in the BroadVision Application Server, there are four IM engines operating in normal mode initially. When one normal engine is switched to a drain-mode engine and then eliminated because all the sessions therein are closed, the script WATCHER detects only 3 IM engines running. A new IM engine is created to replace the eliminated IM engine and the number of existing engines is kept at 4. This maintains a capacity high enough to serve a large number of clients.

The server may be so busy that each memory space occupied by the engines is larger than the given threshold and all the engines operate in drain mode. If this happens, at least one engine occupying smaller memory space than the others will be switched back to normal mode allowing new clients to log onto the server. In the BroadVision Application Server, the two engines with the smallest occupied memory space are switched back to normal mode so that there are at least two engines opening the sessions for new clients.

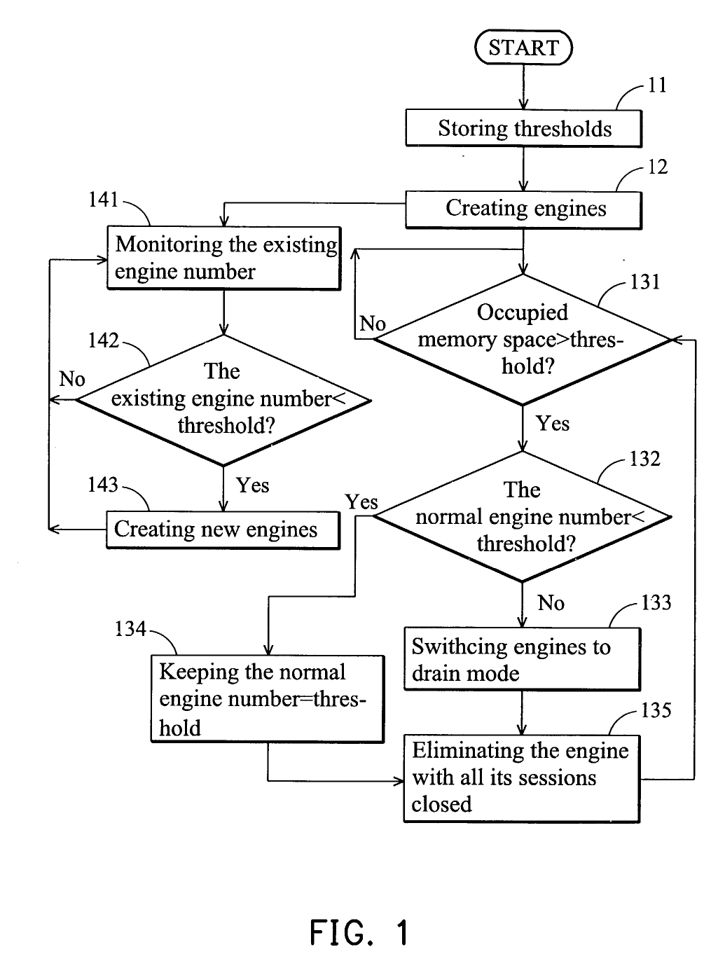

FIG. 1 is a flowchart of a method of crisis management for an application server according to one embodiment of the invention.

In step 11, a first, second and third threshold are stored. They define the largest memory space (500 MB) to be occupied by the IM engines, the lowest number (2) of normal IM engines and the lowest number (4) of existing IM engines.

In step 12, 4 (the third threshold) IM engines are initially created and operate in normal mode. The 4 normal IM engines open sessions for new clients logging onto the application server. After a predetermined period of time during which logged-in clients do not make any request or when the clients log off of the server, the IM engines close the sessions for them.

Next, the following two groups of steps are implemented in parallel.

First, in step 131, an occupied memory space of each IM engine resulting from the opening of the sessions is monitored until it is larger than the first threshold. If it is larger than the first threshold, step 132 is implemented. In step 132, the number of engines operating in normal mode is monitored. If it is larger than the second threshold, step 133 is implemented, wherein the normal IM engine with the occupied memory space larger than the first threshold is switched to drain mode. Otherwise, step 134 is implemented, wherein the IM engine(s) operating in drain mode is(are) switched back to normal mode to maintain the number of the IM engines operating in normal mode above the second threshold (2), and the occupied memory space of the IM engines switched back to normal mode is smaller than those of the other IM engines remaining in drain mode. In step 135, the engines operating in drain mode when all the sessions are closed are eliminated.

Second, in step 141, the number of existing engines is monitored. Step 142 determines whether the number of existing engines is smaller than the third threshold. If the number of existing engines is larger than the third threshold, step 141 is repeated. Otherwise, step 143 is implemented, wherein new IM engine(s) is(are) created to replace the eliminated IM engine(s) and the number of existing engines is kept above or at the third threshold (4), and then step 141 is repeated.

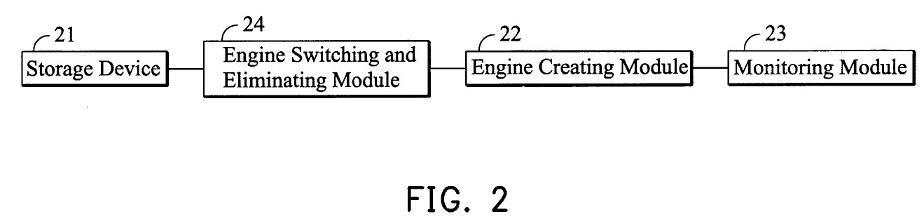

FIG. 2 is a diagram showing a system of crisis management for an application server according to one embodiment of the invention.

A storage means 21 stores a first, second and third threshold. They define the largest memory space (500 MB) to be occupied by the IM engines, the lowest number (2) of normal IM engines and the lowest number (4) of the existing IM engines.

A creating module 22 creates the IM engines operating in a normal mode wherein the IM engines open and close sessions for clients logging onto and off of the application server respectively.

A monitoring module 23 monitors occupied memory space of the IM engines resulting from the opening of the sessions, the number of the IM engines operating in normal mode and the number of the existing IM engines.

A switching and eliminating module 24 switches the engine from normal mode to drain mode wherein the engine does not open sessions for new clients but continues closing sessions for clients logging out when the occupied memory space is larger than the first threshold, and eliminates the engine operating in drain mode when all the sessions are closed. The switching and eliminating module also switches the IM engines operating in drain mode back to normal mode to maintain the number of the IM engines operating in normal mode above the second threshold, wherein the occupied memory space of the IM engines switched back to normal mode is less than that of the other IM engines remaining in drain mode.

The monitoring module 23 monitors the number of the existing IM engines for the creating module 22 to create new IM engines to replace the closed IM engines. This maintains the number of existing IM engines at or above 4 (the third threshold).

The advantages of the previously described embodiment are:

1. Preventing memory space from being used up, eliminating the inconvenience of server shutdown and resetting resulting therefrom.

2. Limiting the memory space occupied by each IM engine, allowing the server to operate smoothly.

3. Automatically creating new IM engines, thereby reducing the workload on the administrator.

4. Uninterrupted web service.

In conclusion, the present invention provides a system and method of memory management for an application server, which prevents engines of the server from using up the memory. The memory usage of the IM engines is monitored using a shell script. The IM engines switch to drain mode when they occupy memory space larger than a given threshold. The IM engines operating in drain mode will not open new sessions for new clients but continue closing sessions for logging-out clients. The drain-mode engines are closed if all the sessions therein are closed, which frees up memory space.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method of crisis management for an application server comprising steps of:
storing a first threshold;
creating an engine operating in a normal mode wherein the engine opens and closes a session for each client logging onto and off of the application server respectively;
monitoring occupied memory space of the engine resulting from the opening of the sessions;
switching the engine from normal mode to drain mode wherein the engine does not open sessions for new clients but continues closing sessions for clients logging out when the occupied memory space is larger than the first threshold; and
shutting down the engine operating in drain mode when all the sessions are closed.

2. The method as claimed in claim 1, wherein the first threshold is 500 MB.

3. The method as claimed in claim 1 further comprising steps of:
storing a second threshold;
creating a plurality of engines operating in normal mode;
monitoring the number of engines operating in normal mode; and
switching the engines operating in drain mode to normal mode to maintain the number of engines operating in normal mode above the second threshold, wherein the occupied memory space of the engines switched to normal mode is less than that of the other engines remaining in drain mode.

4. The method as claimed in claim 3, wherein the second threshold is 2.

5. The method as claimed in claim 1 further comprising steps of:
storing a third threshold; and
creating a plurality of engines operating in normal mode and monitoring the number of existing engines to maintain the number of existing engines above the third threshold.

6. The method as claimed in claim 5, wherein the number of existing engines is monitored periodically.

7. The method as claimed in claim 6, wherein the number of existing engines is monitored every 5 minutes.

8. The method as claimed in claim 5, wherein the third threshold is 4.

9. A system of crisis management for an application server comprising:
means for storing a first threshold;
means for creating an engine operating in normal mode wherein the engine opens and closes a session for each client logging onto and off of the application server respectively;
means for monitoring occupied memory space of the engine resulting from the opening of the sessions; and
means for switching the engine from normal mode to drain mode wherein the engine does not open sessions for new clients but continues closing sessions for clients logging out when the occupied memory space is larger than the first threshold, and shutting down the engine operating in drain mode when all the sessions are closed.

10. The system as claimed in claim 9, wherein the first threshold is 500 MB.

11. The system as claimed in claim 9, wherein the storing means further stores a second threshold, the creating means creates a plurality of engines operating in normal mode, the monitoring means further monitors the number of engines operating in normal mode, and the switching means further switches the engines operating in drain mode to normal mode to maintain the number of engines operating in normal mode above the second threshold, wherein the occupied memory space of the engines switched to normal mode is less than that of the other engines remaining in drain mode.

12. The method as claimed in claim 3, wherein the second threshold is 2.

13. The system as claimed in claim 9, wherein the storing means further stores a third threshold, the creating means creates a plurality of engines operating in normal mode, the monitoring means further monitors the number of existing engines to maintain the number of existing engines above the third threshold.

14. The system as claimed in claim 13, wherein the number of existing engines is monitored periodically.

15. The method as claimed in claim 14, wherein the number of existing engines is monitored every 5 minutes.

16. The method as claimed in claim 13, wherein the third threshold is 4.
